(19) United States
(12) Patent Application Publication
(10) Pub. No.: US 2026/0061909 A1
(43) Pub. Date: Mar. 5, 2026

(54) SEAT CUSHION

(71) Applicant: TOYOTA BOSHOKU KABUSHIKI KAISHA, Aichi (JP)

(72) Inventors: Yoshiomi NISHIGAKI, Ichinomiya-shi (JP); Koji AKAO, Chita-gun (JP)

(73) Assignee: TOYOTA BOSHOKU KABUSHIKI KAISHA, Aichi (JP)

(21) Appl. No.: 19/297,284

(22) Filed: Aug. 12, 2025

(30) Foreign Application Priority Data
Aug. 29, 2024 (JP) 2024-147522

(51) Int. Cl. B60N 2/70

(52) U.S. Cl. CPC B60N 2/7047

(57) ABSTRACT

A seat cushion applied to a vehicle seat is provided. The seat cushion of the present disclosure includes a first support member for supporting an occupant that is situated in a central portion of the seat cushion in seat-width directions and that is elastically deformable, and at least two second support members for supporting the occupant that are separately situated on a first end side and a second end side of the seat cushion in the seat-width directions and that are elastically deformable. The at least two second support members are configured to generate a reaction force greater than a reaction force generated in the first support member.

### CROSS-REFERENCE TO RELATED APPLICATIONS

This application claims the benefit of Japanese Patent Application No. 2024-147522 filed on Aug. 29, 2024 with the Japan Patent Office, the entire disclosure of which is incorporated herein by reference.

### BACKGROUND

The present disclosure relates to a seat cushion of a vehicle seat.

A seat cushion disclosed in International Patent Application Publication WO2018/025796 is known. According to the invention disclosed in International Patent Application Publication WO2018/025796, it has an effect of being able to reduce fatigue in an occupant.

Specifically, a seat cushion disclosed in International Patent Application Publication WO2018/025796 includes a support member that supports the occupant and that extends in front-rear directions of the seat cushion. This support member includes a first support member situated in a central part of the seat cushion in right-left directions of the seat cushion, and second support members separately situated outside the first support member in the right-left directions. The seat cushion also includes restraining portions for making an outside of each of the second support members in the right-left directions harder to sink.

According to the aforementioned seat cushion, a top surface of each of the second support members tends to be postured to face inward in the right-left directions when the occupant sits on the seat cushion due to a function of the restraining portions. In this case, a pressure on a circumference of the ischial bone of the occupant is relatively reduced. According to such a seat cushion, the circumference of the ischial bone and the entirety of the buttocks and the thighs of the occupant can be supported in a balanced manner. Thereby, fatigue in the occupant can be reduced.

### SUMMARY

For a vehicle such as a car, ride quality, comfortableness, reduced fatigue, and the like in a vehicle seat are important factors. Furthermore, such factors are also important in view of supporting safer driving of a vehicle.

Since the past time, supporting safer driving of a vehicle has been an important object. In a vehicle such as a car, the entirety of the vehicle rolls when its travelling direction is changed, and thus a person seated in the vehicle seat (hereinafter referred to as “occupant”) also rolls. Rolling is a rotating or pivoting movement about an imaginary rotational axis extending in the travelling direction.

Particularly, in a case where the occupant is a driver of a car, a large rolling of the occupant may have an adverse effect on driving of the car. The present disclosure will disclose an example of a seat cushion in consideration of such an issue.

A seat cushion applied to the vehicle seat preferably includes at least one of the following elements, for example.

The elements are a first support member for supporting the occupant that is situated in a central portion of the seat cushion in seat-width directions and that is elastically deformable, and at least two second support members for supporting the occupant that are separately situated on a first end side and a second end side of the seat cushion in the seat-width directions and that are elastically deformable. The at least two second support members are configured to generate a reaction force greater than a reaction force generated in the first support member.

In this seat cushion, the reaction force of the second support members can inhibit the occupant from rolling largely when the entirety of the vehicle rolls. For example, in a case where the occupant is the driver of a car, it is possible to reduce adverse effects on driving of the car.

The seat cushion may be configured as below, for example.

Each of the first support member and the at least two second support members includes a pad formed of a foamed material. The pad of each of the at least two second support members desirably has a hardness greater than a hardness of the pad of the first support member.

Each of the first support member and the at least two second support members includes a spring. The spring of each of the at least two second support members desirably has an elastic modulus greater than an elastic modulus of the spring of the first support member.

### BRIEF DESCRIPTION OF THE DRAWINGS

An example embodiment of the present disclosure will be described hereinafter with reference to the accompanying drawings, in which:

FIG. 1 is a diagram showing a vehicle seat; and

FIG. 2 is a conceptual diagram showing a structure of a seat cushion.

### DETAILED DESCRIPTION OF EXEMPLARY EMBODIMENTS

Following “embodiment of the invention” represents an example of embodiments that fall within the technical scope of the present disclosure. In other words, matters used to specify the invention, or the like recited in the claims are not limited to any specific configuration, structure, or the like described in the following embodiment.

The present embodiment is an example of a seat mounted to a vehicle such as a car (hereinafter referred to as “vehicle seat”). Arrows for indicating directions, oblique lines, or the like in each drawing are used to facilitate understanding of mutual relations between the drawings, the shape of members or portions, or the like.

Orientation of the seat cushion is not limited to how the seat cushion is oriented in each drawing. The directions in each drawing are provided to show the orientation of the vehicle seat of the present embodiment when it is assembled to a car. A drawing with the oblique lines does not always represent a cross-sectional view.

With respect to at least a member or a portion explained with a reference numeral, at least one of such a member or a portion is disposed unless it is described using a term such as “only one of”. In other words, unless it is described using a term such as “only one of”, two or more of such a member or a portion may be disposed. The seat cushion of the present disclosure includes at least one of elements, such as at least a member or a portion explained with a reference numeral, or a structural component shown in the drawings.

### First Embodiment

### 1. Outline of Vehicle Seat

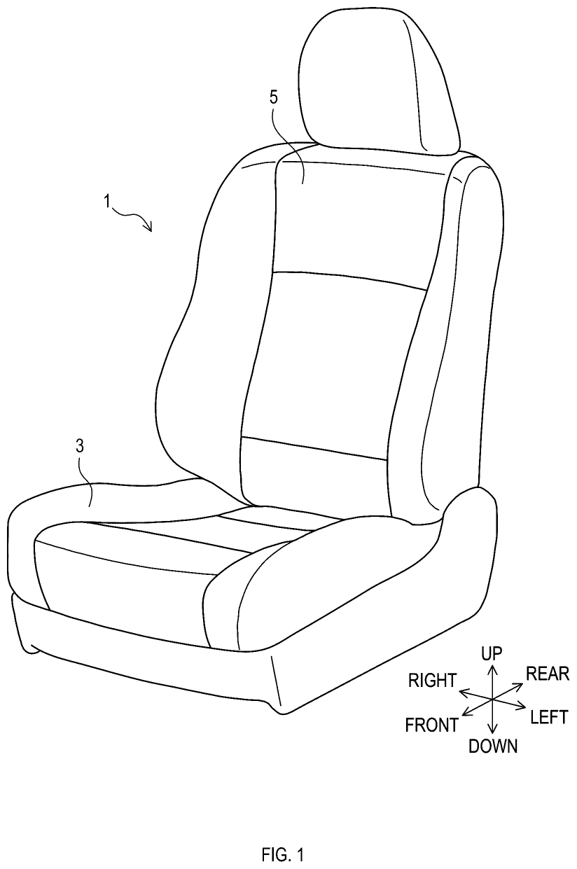

As shown in FIG. 1, a vehicle seat 1 includes a seat cushion 3, and a seatback 5. The seat cushion 3 is a portion for supporting the buttocks of an occupant. The seatback 5 is a portion for supporting the back of the occupant.

### 2. Configuration of Seat Cushion

### <2.1 Outline of Seat Cushion>

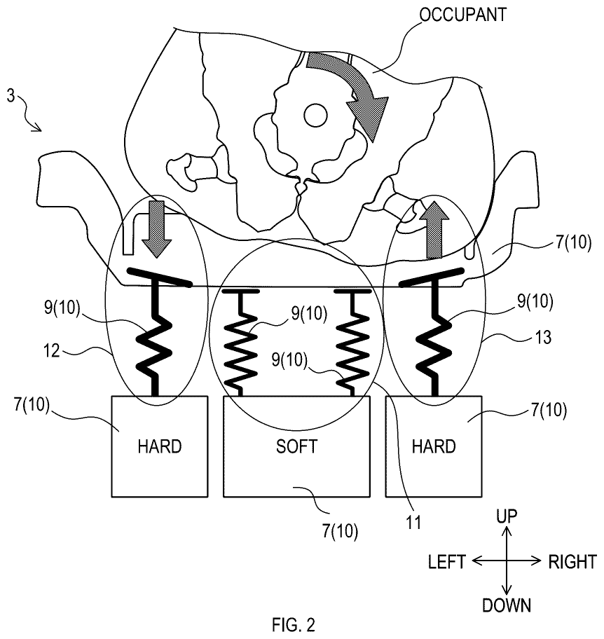

As shown in FIG. 2, the seat cushion 3 includes a cushion pad 7, and at least one (at least two in the present embodiment) spring 9. The form of the seat cushion 3 is retained by a cushion frame (not illustrated) that forms the framework of the seat cushion 3.

The cushion pad 7 and the at least two springs 9 are examples of a support member that is installed in the cushion frame to elastically support the occupant. Specifically, the cushion pad 7 is formed of a foamed material such as foamed urethane and is elastically deformable. The springs 9 are members including metallic wires or the like having a wave-like shape and are elastically deformable.

The cushion pad 7 and the springs 9 coordinate with each other to elastically support the occupant. A support member 10 that will be mentioned in the explanation below is a collective name for the cushion pad 7 and the springs 9.

### <2.2 Configuration of Support Member>

The support member 10 includes a first support member 11 and second support members 12, 13. The first support member 11 is situated in a central portion of the seat cushion 3 in seat-width directions and supports the occupant. The second support members 12, 13 are separately situated on a first end side and a second end side of the seat cushion 3 in seat-width directions and supports the occupant.

The second support members 12, 13 are configured to generate a reaction force that is greater than a repulsive force generated in the first support member 11. Specifically, a hardness of the cushion pad 7 where the second support members 12, 13 are situated is greater than a hardness of the cushion pad 7 where the first support member 11 is situated.

An elastic modulus of the springs 9 of the second support members 12, 13 is greater than an elastic modulus of the springs 9 of the first support member 11. Specifically, the hardness of the cushion pad 7 is adjusted by placing urethane chips, resin plates, or the like inside the cushion pad 7.

### 3. Feature of Seat Cushion in Present Embodiment

In the seat cushion 3, a repulsive force of the second support members 12, 13 is greater than a repulsive force of the first support member 11. Thus, a large repulsive force acts on a right side and a left side of the buttocks of the occupant compared to a central portion of the buttocks of the occupant.

Accordingly, the seat cushion 3 can inhibit the occupant from rolling largely when the entirety of the vehicle rolls. Thus, for example, in a case where the occupant is a driver of a car, it is possible to reduce adverse effects on driving of the car.

### Other Embodiments

In the aforementioned embodiment, it is configured such that the repulsive force of the first support member 11 and the repulsive force of the second support members 12, 13 are different from each other due to the hardness of the cushion pad 7 and the elastic modulus of the springs 9 being different between the first support member 11 and the second support members 12, 13. However, the configuration of the present disclosure is not limited thereto.

For example, it may be configured such that the repulsive force of the first support member 11 and the repulsive force of the second support members 12, 13 are different from each other due to either one of the hardness of the cushion pad 7 or the elastic modulus of the springs 9 being different between the first support member 11 and the second support members 12, 13.

In the aforementioned embodiment, it is configured such that the support member 10 includes the cushion pad 7 and the springs 9. However, the configuration of the present disclosure is not limited thereto. For example, it may be configured such that the support member 10 includes either one of the cushion pad 7 or the springs 9.

In the aforementioned embodiment, an example of a vehicle seat of a car was explained. However, the scope of the disclosure of the present application is not limited thereto. The present disclosure can be applied to a seat used in vehicles such as railroad vehicles, ships and boats, and aircrafts, and also to a stationary seat used in theaters and households, for example.

Furthermore, the present disclosure is only required to coincide with the gist of the disclosure described in the aforementioned embodiments and thus should not be limited to the aforementioned embodiments. Therefore, the present disclosure may include a configuration obtained by combining at least two of the aforementioned embodiments, or a configuration obtained by eliminating the elements in the drawings or the elements described with reference numerals in the aforementioned embodiments.

What is claimed is:

1. A seat cushion applied to a vehicle seat, the seat cushion comprising:
a first support member for supporting an occupant that is situated in a central portion of the seat cushion in seat-width directions and that is elastically deformable,
at least two second support members for supporting the occupant that are separately situated on a first end side and a second end side of the seat cushion in the seat-width directions and that are elastically deformable, the at least two second support members being configured to generate a reaction force greater than a reaction force generated in the first support member.

2. The seat cushion according to claim 1,
wherein each of the first support member and the at least two second support members includes a pad formed of a foamed material, and
wherein the pad of each of the at least two second support members has a hardness greater than a hardness of the pad of the first support member.

3. The seat cushion according to claim 1,
wherein each of the first support member and the at least two second support members includes a spring, and
wherein the spring of each of the at least two second support members has an elastic modulus greater than an elastic modulus of the spring of the first support member.
